(19) United States
(12) Patent Application Publication
(10) Pub. No.: US 2026/0208969 A1
(43) Pub. Date: Jul. 23, 2026

(54) DEVICE FOR DISTRIBUTING ASSEMBLY COMPONENTS PROVIDED WITH AT LEAST ONE COMPONENT EXTRACTOR COMPRISING A PLURALITY OF MUTUALLY MOVABLE PARTS

(71) Applicant: SETI-TEC, COLLEGIEN (FR)

(72) Inventor: Sébastien PEREIRA SANTO, CHARNECA DA CAPARICA (PT)

(21) Appl. No.: 19/140,448

(22) PCT Filed: Dec. 21, 2023
(86) PCT No.: PCT/EP2023/087463

§ 371 Date: Jun. 18, 2025

(30) Foreign Application Priority Data
Dec. 22, 2022 (FR) FR2214313

(51) Int. Cl. B65G 47/14; B21J 15/32; B23P 19/00

(52) U.S. Cl. CPC B65G 47/1478; B21J 15/32; B23P 19/004

(57) ABSTRACT

A device for dispensing assembly components including a container and an extractor of components contained in the container. The extractor is movable along a vertical axis inside the container between a position of taking a plurality of components in the container and a position of extracting the plurality of components out of the container. The movable extractor includes at least one first part and a second movable part, the first and second parts being moved simultaneously between the first and second positions, the first part including a first housing capable of receiving several components of the plurality of components, and the second part including a second housing capable of receiving a component of the plurality of components. The two parts are movable in translation with respect to each other along the vertical axis. At least one of the parts is configured to take a unitary dispensing position.

### 1. CROSS-REFERENCE TO RELATED APPLICATIONS

This Application is a Section 371 National Stage Application of International Application No. PCT/EP2023/087463, filed Dec. 21, 2023, and published as WO 2024/133799 A1 on Jun. 27, 2024, not in English, which claims priority to and the benefit of French Patent Application No. FR2214313, filed Dec. 22, 2022, the contents of which are incorporated herein by reference in their entireties.

### 2. TECHNICAL FIELD

The field of the invention is that of designing and making assembly-component dispensing devices used in industry, in particular aeronautics, to transfer fastening elements between a supply area and a dispensing area.

### 3. PRIOR ART

Assembly components (such as screws, rivets, or others) are commonly used in industry to make assemblies. In particular, the aeronautical industry uses countersunk head rivets with the advantage of having a head surface that is flush with the riveted structure after assembly, which offers less resistance to aerodynamic flow. These rivets therefore have a cylindrical or low conicity body, and a head the diameter of which is greater than the mean diameter of the body.

For this purpose, it is necessary to move these assembly components from a supply area where they are stored to a distribution area where they are brought with a view to being subsequently positioned by means of an assembly tool.

Among the known solutions, there are devices for storing and distributing assembly components which respectively comprise:
a container, provided with a bottom, suitable for containing such assembly components, and
an extractor of assembly components contained in the container.

Such an extractor is commonly movable along a vertical axis inside the container between:
a first position of taking a plurality of assembly components from the bottom of the container, and
a second position for extracting the plurality of assembly components from said container.

According to an alternative, known from document JPS62180824 A in particular, the extractor can also be movable along an oblique axis, inclined with respect to a vertical axis, between the two positions in question.

However, such assembly-component extractors are quite inefficient, inaccurate and/or complex and can therefore be improved.

It is therefore still possible to improve devices of this type, which constitutes an objective pursued by the invention.

### 4. PRESENTATION OF THE INVENTION

The proposed technique relates to an assembly-components dispensing device comprising:
a container, provided with a bottom, suitable for containing assembly components,
an extractor of assembly components contained in the container, the extractor being movable along a vertical axis inside the container between:
   a first position for taking a plurality of assembly components from the bottom of the container, and
   a second position for extracting the plurality of assembly components from the container.

According to the invention, the movable extractor comprises at least one first part and a second part, the first and second parts being moved simultaneously between the first and second positions. Furthermore, the first part comprises a first housing capable of receiving a plurality of assembly components of the plurality of assembly components, and the second part comprises a second housing capable of receiving an assembly component of the plurality of assembly components.

Furthermore, the two parts are movable in translation relative to one another along the vertical axis and at least one of the movable parts is configured to take a third unitary dispensing position in which the assembly component contained in the second housing of the second part is longitudinally offset, along the vertical axis, from the assembly components contained in the first housing of the first part.

In other words, the extractor, which is movable vertically, makes it possible, firstly, to extract a plurality of assembly components from the associated container and, secondly, to isolate a single assembly component belonging to this plurality of assembly components. In particular, this makes it possible to improve the accuracy and efficiency of the extraction of an assembly component. This is because, in doing so, the isolated assembly component is easier to pre-take by a dedicated gripping means. By isolating the assembly component, the probability of this gripping device colliding with another assembly component is low or even zero.

In particular, this results in an improvement in the extraction operation of the assembly components, out of the container, for subsequent transfer to an assembly station.

Furthermore, the vertical movement of the extractor allows its second part, when it is in the unitary dispensing position (third position), to present the assembly component vertically. Thus a gripping means located above and coaxially with the assembly component can easily apply a gripping force, by suction effect for example, uniformly and continuously on the head of the assembly component. In particular, this results in an efficient gripping and safe movement of the assembly component, unlike previous solutions where the extractor is movable along an oblique axis. This is because, in such solutions, the assembly component is also arranged obliquely. However, under the effect of gravity, the assembly component tends to take a vertical orientation. As a result, there is a risk of the assembly component tipping over and thus breaking the seal between the component head and the gripping means. This results in a detachment of the assembly and a fall of the assembly component.

Moreover, the vertical movement of the extractor, combined or not with a gripping means also movable along a vertical axis, makes it possible to minimise the radial space requirement (footprint) of the dispensing device, unlike previous solutions implementing an extractor movable along an oblique axis.

Furthermore, the fact that the first and second parts of the extractor are movable together (i.e. moved simultaneously) between the first position of taking and the second position for extracting, and vice versa, has many advantages. Such an arrangement makes it possible in particular to best preserve the integrity of the assembly components, in particular those located in the vicinity of the junction of the two parts of the extractor. This is because, for such assembly components (rivets or screws for example), a potential friction or shocks between the head of the assembly component contained in the first part against the second part is avoided, during a supposed isolated movement of the first part alone between the second position and the first position. The preservation of the integrity of the component means the preservation of its surface treatment, its surface condition and/or its geometry.

Such an arrangement also makes it possible to improve the cycle time insofar as an assembly component is forced to load into the second part of the extractor when the first and second parts are plunged into the container (switching from the second position to the first position).

According to a particular feature of the device, the first and second housings define a slot for receiving the plurality of assembly components, the second housing forming a longitudinal end of the slot.

Such an arrangement particularly allows the mobile extractor to substantially have the form of an extraction blade. This therefore translates into a reduction in the footprint of the extractor, and therefore, by extension, of the device in which it is used. Furthermore, the use of such a slot makes it possible in particular to align the assembly components so as to simplify the extraction and dispensing thereof. Such a slot also makes it possible to ensure a gradual movement of assembly components present therein. In other words, such an arrangement of the housings makes it possible to improve the accuracy and/or efficiency of the extraction of the assembly components.

According to another particular feature of the device, the first part has an upper surface from which the first housing is provided, the upper surface being inclined relative to the vertical axis and oriented in the direction of the second housing.

Such an arrangement particularly allows the several assembly components of said plurality of assembly components to slide, under the effect of gravity, towards the second housing with a view to successively supplying it with assembly components. More precisely, the inclined top surface, combined with the effect of gravity, automatically causes the sliding of the assembly components contained in the first housing to and within the second housing. This first part forms an intermediate cartridge of assembly components. In particular, this results in an improvement in the rate of dispensing the assembly components.

According to another particular feature of the device, and knowing that each assembly component comprises a body having a predetermined diameter and length and a head having a predetermined diameter, the slot has a depth greater than the predetermined length of the assembly component and a width less than the predetermined head diameter and greater than the body diameter of the assembly component so as to allow positioning thereof along the vertical axis.

Thus each assembly component is supported, at its maximum diameter (typically a screw head or a rivet flange), by the upper surface of the first part of the extractor, or even by the edge of the first housing thereof, while the body of this same assembly component is, in whole or in part, located in this housing. Then, under the effect of gravity, and if no elements (typically other assembly components present in the container) block them, the assembly components located in the first housing, and which fit therein, orient substantially vertically. In particular, this makes it possible, in the long term, to simplify the gripping of the assembly component contained in the second housing.

In other words, the slot has a predetermined depth that can make it possible to extract and transfer assembly components of different lengths.

According to another particular feature of the device, the second part has a conformation capable of preventing a movement of the assembly component out of the second housing in a horizontal direction, relative to the vertical axis, when moving the second part from the second position to the third position.

Such a conformation makes it possible in particular to ensure the holding in position of the assembly component contained in the second housing during the translations of the second part of the extractor, from the position for extracting to the unitary dispensing position in particular. This eliminates any untimely extraction of this assembly component, in particular due to vibrations and/or jolts of the device. In particular, this results in an improvement in the performance of the device.

To this end, the conformation is preferably of complementary shape to that of the head of the assembly component.

According to another particular feature of the device, the second part comprises, in line with the second housing along the vertical axis, a protrusion oriented substantially perpendicular to the vertical axis, the protrusion being configured to extend partially inside the first housing of the first part below the assembly components contained in the first housing.

The protrusion is located below the assembly components contained in said first housing when the extractor is in the first and second positions. Such a protrusion particularly allows the assembly component adjacent to that contained in the second housing not to rub against the edges of the second housing of the second part. More precisely, when moving the second part from its second position to its third position, the neighbouring assembly component is lifted by this protrusion and falls back into the container. Such a protrusion therefore makes it possible to prevent the head of this neighbouring assembly component from being damaged during friction. This helps in particular to ensure the integrity of the assembly components and of the device itself.

According to another particular feature of the device, the second part comprises a sensor for the presence of the assembly component contained in the second housing of said second part.

The use of such a sensor makes it possible in particular to ensure the presence of an assembly component in the second housing of the second part before initiating the translation of one of the parts of the extractor with a view to reaching the unitary dispensing position.

According to another particular feature of the device, it comprises means for visually checking the assembly component contained in the second housing of the second part.

Such visual checking means make it possible in particular to check the integrity of the assembly component in order to avoid conveying a defective assembly component to the remote workstation, or even that it uses it. Such visual checking means also make it possible to verify that the assembly component contained in the second housing corresponds to the type of assembly component required. For example, such checking means make it possible to check that a screw is not inadvertently present in a rivet container. Such checking therefore ensures the safety of end users, such as aircraft passengers, for example.

### 5. LIST OF FIGURES

Further features and advantages of the invention will become apparent on reading the following description of a specific embodiment, given merely by way of illustrative and non-limiting example, and the appended drawings, wherein:

FIG. 1 illustrates, in a raised perspective view, an example of a plant for storing and dispensing assembly components comprising a plurality of devices for dispensing assembly components according to the invention;

FIGS. 2A and 2B illustrate, in two perspective views, an isolated device for dispensing assembly components of FIG. 1;

FIGS. 3A and 3B illustrate, in cross-sectional views, the device for dispensing assembly components of FIGS. 2A and 2B;

FIG. 4 illustrates, in plan view, the device for dispensing assembly components of FIGS. 2A and 2B;

FIG. 5 is a flow chart of the main operating steps of a device for dispensing assembly components in accordance with the invention; and

FIGS. 6A, 6B and 6C illustrate, in cross-sectional views, the main steps of the flow chart of FIG. 5 applied to the device for dispensing assembly components of FIGS. 2A and 2B.

### 6. DETAILED DESCRIPTION OF THE INVENTION

### 6.1 Description of an Illustrative Embodiment

The invention relates to an assembly-component dispensing device, which is a constituent element of a more global assembly-component storage and dispensing plant.

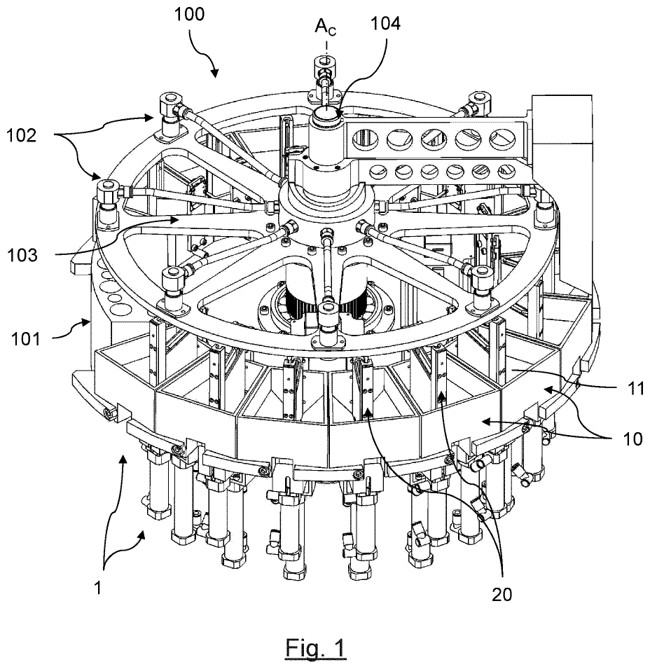

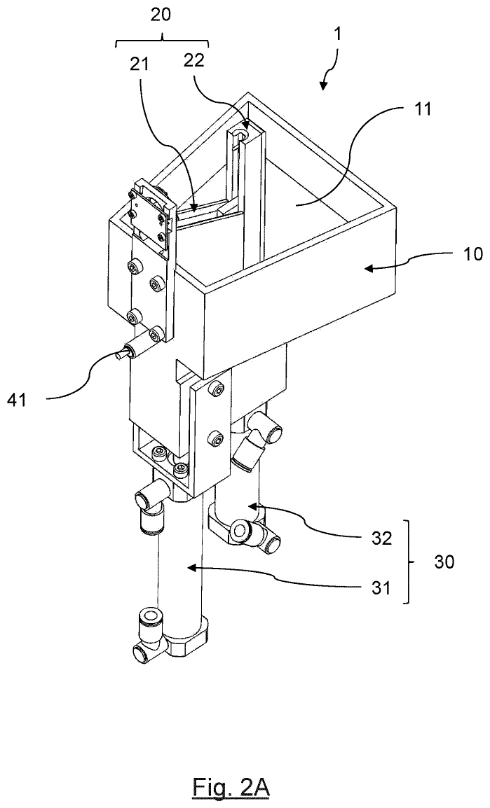

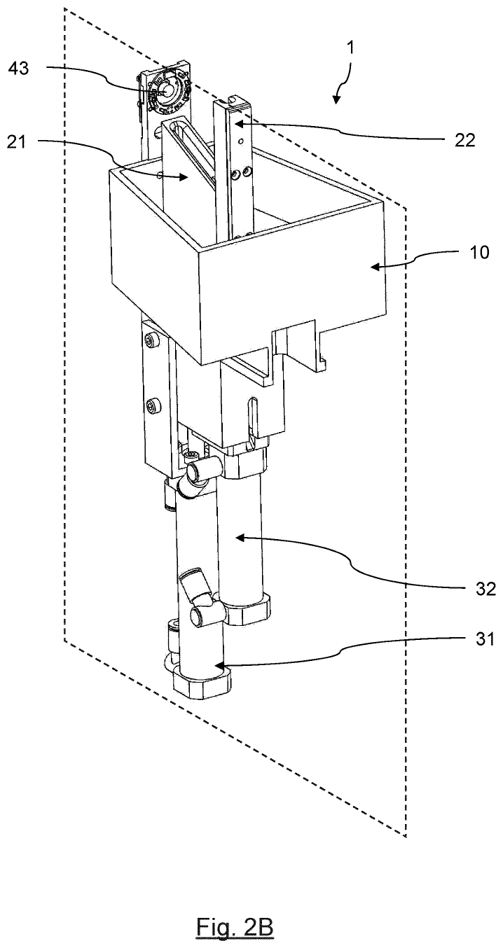

For reasons of clarity and understanding of the invention, such a plant is briefly described in relation to FIG. 1. The assembly-component dispensing device is then detailed in relation to FIGS. 2 to 4, for the structural aspects, and 5 to 6C, for the functional aspects.

FIG. 1 illustrates, in a raised perspective view, an example of an assembly-component storage and dispensing plant comprising a plurality of assembly-component dispensing devices according to the invention.

The assembly-component storage and dispensing plant 100 comprises a plurality of assembly-component dispensing devices 1 each comprising:
a container 10, provided with a bottom 11, suitable for containing assembly components, and
an extractor 20 of assembly components contained in the container 10.

Such an extractor 20 is movable, along a vertical axis, inside the container between a first position for taking a plurality of assembly components from the bottom 11 of the container 10, and a second position for extracting this plurality of assembly components.

The plant 100 for storing and dispensing assembly components furthermore comprises means 101 for conveying assembly components extracted from the containers 10, by the extractors 20, to at least one remote workstation (not shown), such as a robotic arm equipped with at least one member for assembling the assembly components.

The plant 100 for storing and dispensing assembly components further comprises means 102, 103 for transferring to the conveying means 30, assembly components extracted from the containers 10 by the extractors 20.

A storage and dispensing plant for assembly components therefore makes it possible to selectively extract assembly components from associated containers and then transport these extracted assembly components to a workstation where they are used.

In the illustrated example, the assembly-component dispensing devices 1 and the conveying means 101 are arranged radially around a central axis AC of a central shaft 104.

The transfer means comprise a plurality of means 102 for gripping at least one assembly component extracted by the associated extractor 20, respectively carried by an arm 103 movable in rotation about the central axis AC.

FIGS. 2A, 2B, 3A, 3B and 4 illustrate, in various views, an example of a device for storing and dispensing assembly components in accordance with an embodiment of the invention.

The assembly-component dispensing device 1 comprises the container 10, suitable for containing assembly components (not shown), and the extractor 20 of assembly components contained in this container 10.

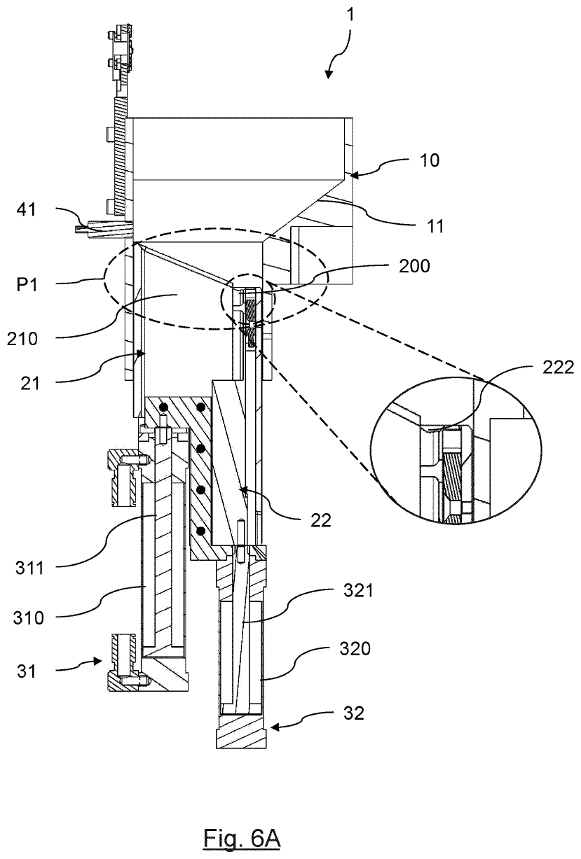

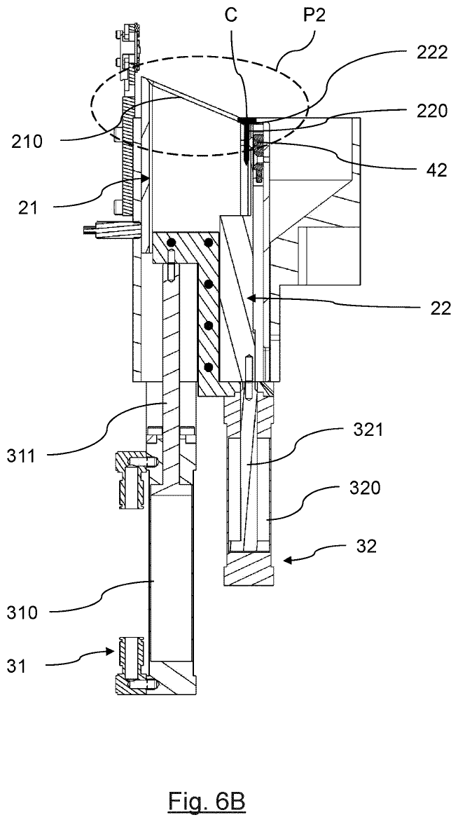

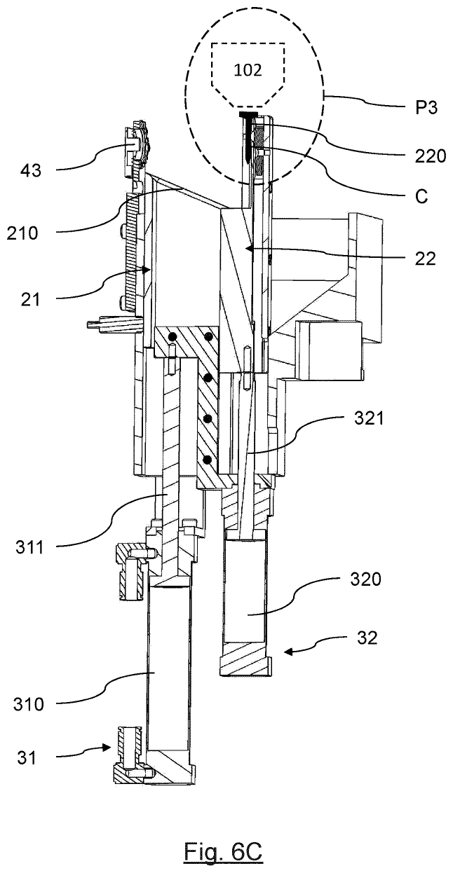

The extractor 20 is movable along a vertical axis X inside the container between the first position P1, shown in FIG. 6A, of taking a plurality of assembly components from the bottom 11 of the container 10, and a second position P2, shown in FIG. 6B, of extracting this plurality of assembly components from the container 10.

The device 1 furthermore comprises means 30 for moving the extractor 20 from the first position for taking P1 to the second position for extracting P2, and vice versa.

According to the invention, the movable extractor 20 comprises a first part 21, comprising a first housing 210 capable of receiving several assembly components of the plurality of assembly components, and a second part 22, comprising a second housing 220 capable of receiving a single assembly component of the plurality of assembly components.

Furthermore, the first and second parts 21, 22 are movable in translation with respect to one another along the vertical axis X. The second part 22 is also configured to take a third position P3, shown in FIGS. 2A and 6C in particular, of unitary distribution of the assembly component.

Thus, in the third unitary dispensing position P3, the assembly component contained in the second housing 220 of the second part 22 is longitudinally offset, along the vertical axis, from the assembly components contained in the first housing 210 of the first part 21. In other words, the assembly component contained in the second housing 220 of the second part 22 is isolated from the other assembly components. In particular, this makes it possible to simplify the movement of this isolated assembly component by the transfer means 102, 103 of the plant 100.

In this embodiment, the first and second housings 210, 220 are provided from upper surfaces 211, 221 of the first and second parts 21, 22 respectively.

The first and second housings 210, 220 are furthermore aligned and open to each other so as to define a slot for receiving assembly components present in the container 10. The second housing 220 forms one of the longitudinal ends of the slot.

Thus the extractor has substantially the form of a movable blade.

The first housing 210 housing has, on the vertical axis, a predetermined depth P210, greater than the length of the assembly component and, perpendicularly to the vertical axis, a predetermined width I210, less than the maximum diameter of this same assembly component. Obviously the depth P210 and the width I210 of the first housing 210 are determined according to the dimensions of the assembly components to be extracted.

A first housing 210 thus sized allows the assembly components disposed therein to be oriented along the vertical axis when the extractor 20 is in the second position for extracting P2. Indeed, each assembly component is supported, at its maximum diameter (typically a screw head or a rivet flange), by the upper surface 211, or even by the edge of the first housing 210, while the body of this same assembly component is, in whole or in part, located in this housing.

Thus, when the extractor 20 is moved from the first position for taking P1 to the second position for extracting P2, the assembly components present in the container 10 will gradually be inserted in the receiving slot (formed by the first and second housings 210, 220) and be oriented vertically.

In the illustrated example, the upper surface 211 of the first part 21 of the extractor 20 is inclined, relative to the vertical axis X, and oriented in the direction of the second housing 220.

Such an arrangement particularly allows the several assembly components of said plurality of assembly components to slide, under the effect of gravity, towards the second housing with a view to successively supplying it with assembly components.

Preferentially, this edge is bevelled/chamfered so as to adapt to the assembly components with different geometries and/or of different types, and/or to simplify the sliding thereof towards the second housing.

Furthermore, the second housing 220 is shaped to hold said assembly component contained therein, in particular in a horizontal direction.

Such an arrangement makes it possible in particular to ensure the holding in position of the assembly component during the translation of one of the parts of the extractor with a view to reaching the unitary dispensing position.

To this end, in the illustrated example, the second housing 220 comprises a conformation 222, visible in FIG. 4 in particular, substantially having the shape of a frustoconical arc of a circle the most splayed part of which forms the upper part of the second housing 220. Such a conformation makes it possible to receive and hold the head of all types of assembly component when moving the second part 22.

Such a conformation 222 is, in the illustrated example, obtained by a (tapered) countersink applied to the second housing 220 after formation thereof.

As a result, a portion of the countersink is notched by the slot and is therefore partially missing. However, there is still a part of the countersink that can oppose the movement of the assembly component in a horizontal direction by means of an undercut effect.

Obviously, and as will be detailed later, for the assembly component to be able to pass from the first housing 210 to the second housing 220, by gravity effect, it is necessary that the upper surface 221 of the second part 22 be located below the upper surface 211 of the first part 21 when the second part 22 is in the second position for extracting so that the conformation 222 does not block the head of the assembly component.

Furthermore, the second part 22 of the extractor 20 comprises a stop 223 for holding said assembly components contained in said first housing of said first part.

In the illustrated example, the stop 223 is formed by a protrusion located in line with the second housing 220 along the vertical axis X and oriented perpendicular to this vertical axis X.

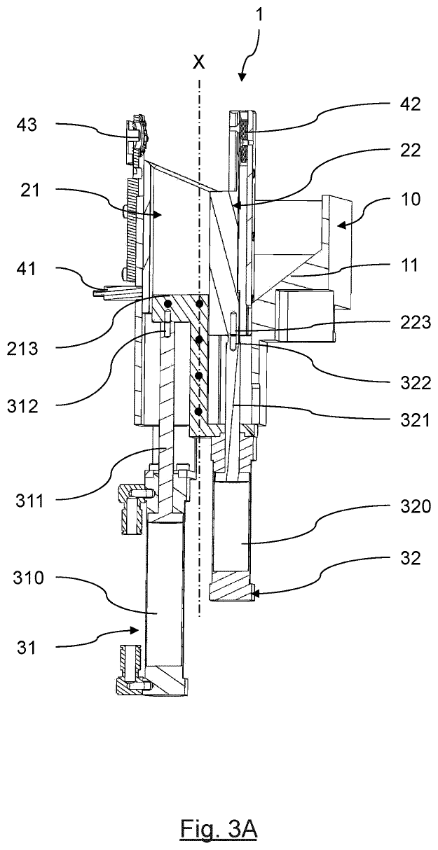

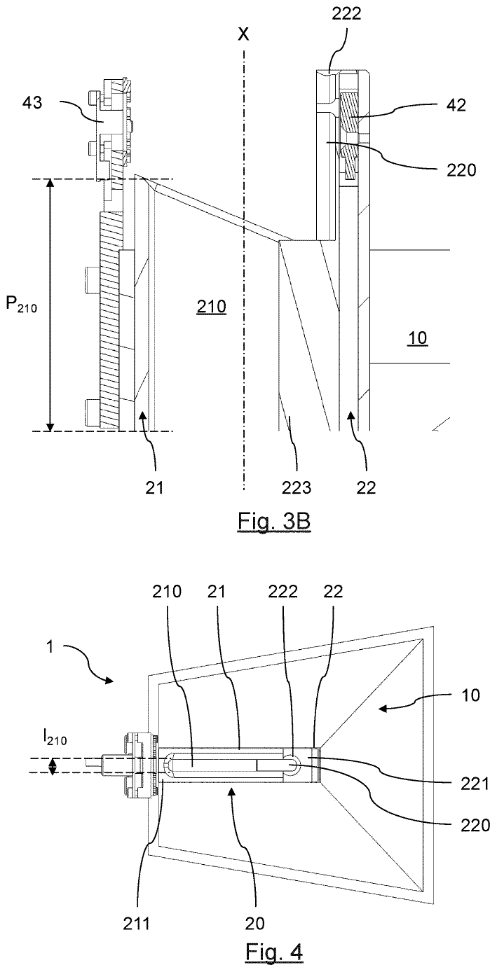

The protrusion 223 is further configured to extend partially inside the first housing 210 of the first part 21 so as to form a stop for holding the assembly components contained in the first housing 210 of the first part 21 when the second part 22 is in the third unitary dispensing position P3, as illustrated in FIG. 3B in particular.

To this end, the protrusion 223 has substantially the shape of a parallelepiped the thickness of which corresponds to the width 1210 of the first housing 210. Obviously, other forms of protrusion can be envisaged, particularly depending on the nature of the assembly components to be held.

Such a protrusion 223 also makes it possible to ensure a translational guidance of the second part 22 of the extractor 20 with respect to the first part 21 of this same extractor.

Moreover, the movement means 30 comprise, in this embodiment, two cylinders 31, 32 associated with the first and second parts 21, 22 respectively to enable their relative translation along the vertical axis X.

The first cylinder 31 comprises a hollow body 310, secured to the container 10, within which slides a rod 311 the free end 312 of which is secured to a lower portion 213 of the first part 21 of the extractor 20.

The second cylinder 32 comprises a hollow body 320, secured to the lower portion 213 of the first part 21 of the extractor 20, within which slides a rod 321 the free end 322 of which is secured to a lower portion 223 of the second part 22 of the extractor 20.

Thus the first cylinder 31 makes it possible to simultaneously move the first and second parts 21, 22, when translating from the first position for taking to the second position for extracting, and vice versa. The second cylinder 32 for its part makes it possible to move only the second part 22, when translating from the second position for extracting to the third unitary dispensing position.

Furthermore, the device 1 for dispensing assembly components comprises a plurality of sensors making it possible in particular to ensure correct operation of the device.

A first sensor 41 is configured to detect the presence of assembly components in the container 10 so as to ensure that the extractor 20 has assembly components to be taken that it reaches in the first position for taking P1.

In the illustrated example, the first sensor 41 is located substantially at the bottom 11 of the container 10 and positioned so as to define a low threshold of filling the container 10 with assembly components.

A second sensor 42 is configured to detect the presence of the assembly component contained in the second housing 220 of the second part 22 of the extractor 2.

Such a sensor makes it possible in particular to ensure the presence of an assembly component in the second housing of the second part before initiating the translation of the second part to the third unitary dispensing position.

In the illustrated example, the second sensor 42 is housed in the second part 22 at the second housing 220 and opposite it.

A third sensor 43 is configured to provide a visual check of the assembly component contained in the second housing 220 of the second part 22 of the extractor 20.

Such visual checking means make it possible in particular to check the integrity of the assembly component and/or a match thereof (a screw inadvertently present in a rivet container, for example).

In the illustrated example, the third sensor 43 is a camera carried by the container 10 substantially at the third unitary dispensing position P3 and oriented perpendicular to the vertical axis X.

The device 1 furthermore comprises a processing unit (not shown) configured to control the actuation of the movement means 30, and therefore the movement of the extractor 20, in particular according to the data signals from the sensors 41, 42, 43 and instructions provided by a user and/or another device of the plant 100.

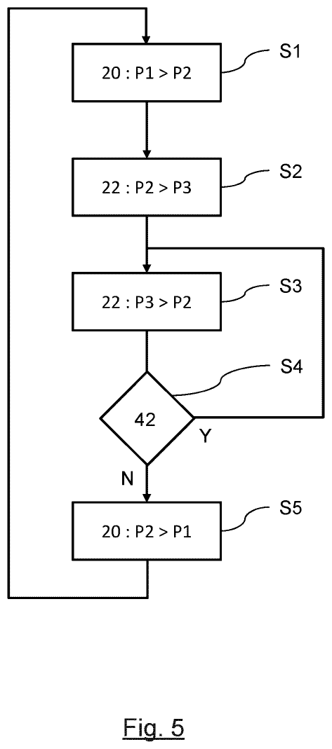

FIGS. 5 to 6C illustrate, in cross-sectional views, the main operating steps of the assembly-component dispensing device described previously.

In the initial position of the device 1, illustrated in FIG. 6A, the extractor 20 is in the first position P1 of taking a plurality of assembly components from the bottom 11 of the container 10. In such a first position for taking P1, the extractor 20 is located under the bottom 11 of the container 10. In the illustrated example, the second housing 220 is located substantially below the level of the neighbouring end of the first housing 210 so as to prevent the conformation 222 of second housing 220 from preventing the insertion of an assembly component therein. To allow such a positioning of the extractor 20, the cylinders 31, 32 coupled to the first and second parts 21, 22 are retracted, i.e. the rods 311, 321 are essentially stored in their respective bodies 310, 320. Thus, if assembly components are present in the container (information obtained via the first sensor 41), a plurality of assembly components thereof are inserted into the first and second housings 210, 220 of the first and second parts 21, 22 of the extractor 20.

Such a device 1 for dispensing assembly components comprises in particular the following main steps:
in a first step S1, illustrated in FIG. 6B, the extractor 20 is moved from the first position for taking P1 to the second position P2 for extracting, out of the container 10, the plurality of assembly components contained in the first and second housings 210, 220 of the first and second parts 21, 22 of the extractor 20. To do this, the rod 311 of the cylinder 31 coupled to the first part 21 extends gradually. The cylinder 32 coupled to the second part 22 for its part remains retracted. When the extractor 20 is moved, the assembly components C disposed therein are oriented substantially vertically. The second sensor 42 detects, in the absence of an unexpected event, the presence of a single assembly component located in the second housing 220 of the second part 22 and held by the conformation 222.
in a second step S2, illustrated in FIG. 6C, the second part 22 of the extractor 20 is moved from the second position for extracting P2 to the third position P3 for unitary dispensing of the assembly component C contained in the second housing 220. To do this, the rod 321 of the cylinder 32 coupled to the second part 22 extends gradually. The rod 321 of the cylinder 31 coupled to the first part 21 for its part remains extended. When moving the second part 22, the third sensor 43 ensures a visual check of the assembly component C. If the check is positive, when the second part 22 reaches the third unitary dispensing position P3, the assembly component C is pre-taken by a dedicated gripping means 102 belonging to the plant 100.
in a third step S3, the second part 22 of the extractor 20 is moved from the third unitary dispensing position P3 to return to the second position for extracting P2. To do this, the rod 321 of the cylinder 32 coupled to the second part 22 is gradually retracted. The rod 321 of the cylinder 31 coupled to the first part 21 for its part remains extended.
in a fourth step S4, when the second part 22 has returned to the second position for extracting P2 and the second sensor 42 detects the presence of another assembly component in the second housing 220 of the second part 22, then the second step S2 is repeated. The inclined upper surface 211 of the first part 21, combined with the effect of gravity, automatically causes the assembly components contained in the first housing 210 to slide toward and into the second housing 220. The first part 21 of the extractor forms a cartridge of assembly components.
in a fifth step S5, when the second part 22 has returned to the second position for extracting P2 and, for a predetermined period of time (two seconds for example), the second sensor 42 does not detect the presence of any assembly component in the second housing 220 (empty cartridge), then the extractor 20 is moved from the second position for extracting P2 to the first position for taking P1, and thus returns to the initial step. To do this, the rod 311 of the cylinder 31 coupled to the first part 21 retracts gradually. The cylinder 32 coupled to the second part 22 remains retracted.

### 6.3 Other Embodiments and Variants

In the illustrated embodiment, the extractor comprises two parts able to move in translation with respect to one another along the vertical axis. However, in another embodiment, not illustrated, the extractor comprises three or more parts able to move in translation with respect to one another along the vertical axis. Such an arrangement particularly allows precise control of the supply of the second housing with assembly components present in the first housing distributed over several movable parts.

In the illustrated embodiment, the second part 22 of the extractor 20 is configured to take the third position P3 of unitary dispensing of the assembly component. However, in another embodiment, not illustrated, the first part of the extractor is configured to take the third position of unitary dispensing of the assembly component. In other words, unlike the illustrated embodiment in which the second part is moved upward, in this other embodiment it is the first part that is moved downward.

In the illustrated embodiment, the movement means 30 comprise two cylinders 31, 32 associated with the first and second parts 21, 22 respectively to enable their relative translation along the vertical axis X. However, in another embodiment, not illustrated, the movement means comprise a single cylinder, connected to an intermediate structure at the first and second parts, and a stop in translation of the first part of the extractor in the position for extracting. Thus, when the cylinder is activated from the first position for taking to the third dispensing position, the cylinder initially ensures a simultaneous movement of the two parts of the extractor. Then, when the first part comes into contact with the stop in the position for extracting, the second part continues its translation alone to the dispensing position. In particular, the use of a single cylinder makes it possible to simplify the structure of the assembly-component dispensing device. This means, in particular, that the maintenance of the device is simplified.

In another embodiment, not illustrated, the assembly-component dispensing device is devoid of the sensor for the presence of the assembly component contained in the second housing and/or the means for visually checking the assembly component contained in the second housing. Such an arrangement in particular simplifies the structure of the device and therefore limits the manufacturing costs thereof.

Obviously, the invention is not limited to the embodiments described above and provided merely by way of examples. It encompasses various modifications, alternative forms and other variants that a person skilled in the art can consider in the context of the present invention and in particular all combinations of the various operating modes described before, which can be considered separately or in combination.

More generally, the invention covers all implementations of the principle according to which an extractor, movable vertically, makes it possible, firstly, to extract a plurality of assembly components from the associated container and, secondly, to isolate a single assembly component belonging to this plurality of assembly components.

According to various aspects, the proposed technology therefore has all or some of the following advantages, depending on the adopted embodiments:
making it possible to improve the accuracy and/or efficiency of the extraction of an assembly component;
making it possible to improve the rate of dispensing assembly components;
adapting to assembly components of different geometries and/or types;
guaranteeing a long service life;
requiring limited maintenance;
limiting manufacturing costs;
ensuring end-user safety;
etc.

An exemplary aspect of the present disclosure provides an effective solution to at least some of the various problems discussed above with respect to the prior art.

An exemplary aspect of the disclosure, according to at least one embodiment, improves the operation of extracting the assembly components from an associated container.

In particular, an exemplary aspect, according to at least one embodiment, provides a device for dispensing assembly components provided with a unit extractor for improving the accuracy and/or efficiency of the extraction of an assembly component with a view to a subsequent transfer to an assembly station.

Another exemplary aspect, according to at least one embodiment, provides such an extractor for improving the rate of extraction and dispensing of the assembly components.

Another exemplary aspect, according to at least one embodiment, provides such an extractor for ensuring the integrity and/or suitability of the extracted assembly components.

Another exemplary aspect, according to at least one embodiment, provides such an extractor adapted to assembly components of different geometries and/or types.

Another exemplary aspect provides, in at least one embodiment, such a device for dispensing assembly components that is simple to implement and/or economical.

Although the present disclosure has been described with reference to one or more examples, workers skilled in the art will recognize that changes may be made in form and detail without departing from the scope of the disclosure and/or the appended claims.

1. Assembly-component dispensing device comprising:
a container, provided with a bottom, suitable for containing assembly components,
an extractor of assembly components contained in said container, said extractor being movable along a vertical axis inside said container between:
a first position for taking a plurality of assembly components from said bottom of said container, and
a second position for extracting said plurality of assembly components from said container,
wherein said movable extractor comprises at least a first part and a second part, said first and second parts being moved simultaneously between said first and second positions, and
wherein said first part comprises a first housing capable of receiving a plurality of assembly components of said plurality of assembly components, and
said second part comprises a second housing capable of receiving an assembly component of said plurality of assembly components,
said first and second parts being movable in translation with respect to one another along said vertical axis, at least one of said first and second parts being configured to take a third unitary dispensing position in which said assembly component contained in said second housing of said second part is longitudinally offset, along said vertical axis, from the assembly components contained in said first housing of said first part.

2. The assembly-component dispensing device according to claim 1, wherein said first and second housings define a slot for receiving said plurality of assembly components, said second housing forming a longitudinal end of said slot.

3. The assembly-component dispensing device according to claim 2, wherein said first part has an upper surface from which said first housing is provided, said surface being inclined with respect to the vertical axis and oriented toward said second housing.

4. The assembly-component dispensing device according to claim 1, said plurality of assembly components comprising a body having a predetermined diameter and length and a head having a predetermined diameter, wherein said slot has a depth greater than the predetermined length of said assembly component and a width less than the predetermined head diameter and greater than the body diameter of said assembly component so as to allow positioning thereof along the vertical axis.

5. The assembly-component dispensing device according to claim 2, wherein said second part has a conformation capable of preventing a movement of said assembly component out of said second housing in a horizontal direction, relative to said vertical axis, when moving said second part from said second position to said third position.

6. The assembly-component dispensing device according to claim 5, wherein said conformation is of complementary shape to that of said head of said assembly component.

7. The assembly-component dispensing device according to claim 1, wherein said second part comprises, in line with said second housing along said vertical axis, a protrusion oriented substantially perpendicular to said vertical axis, said protrusion being configured to extend partially within said first housing of said first part below the assembly components contained in said first housing.

8. The assembly-component dispensing device according to claim 1, wherein said second part comprises a sensor for a presence of said assembly component contained in said second housing of said second part.

9. The assembly-component dispensing device according to claim 1, which comprises a sensor for visually checking said assembly component contained in said second housing of said second part.
